(19) United States
(12) Patent Application Publication
(10) Pub. No.: US 2012/0311887 A1
(43) Pub. Date: Dec. 13, 2012

(54) Therapeutic Shoe Sole and Methods of Manufacturing the Same

(76) Inventor: Peter Wong, Sacramento, CA (US)

(21) Appl. No.: 13/477,055

(22) Filed: May 22, 2012

Related U.S. Application Data
(60) Provisional application No. 61/495,911, filed on Jun. 10, 2011.

(51) Int. Cl. A43B 13/18; B32B 38/04; B32B 37/24; B32B 37/14

(52) U.S. Cl. 36/28; 156/60; 156/256; 156/242

(57) ABSTRACT

A therapeutic shoe sole includes an outsole, a medial and a lateral support, an energy return strip, and a midsole. The energy return strip includes carbon fiber and glass fiber layers laminated together and, may also include multiple sections with varying thickness and compositions. The midsole includes a shock absorptive material that curves upward at the heel and toe regions to form a “rocker” design. The midsole may also include cutouts to reduce weight, and include a silicon pad at the heel region for shock absorption.

### CROSS REFERENCE TO RELATED APPLICATIONS

This application is related to and claims the priority of Provisional Application No. 61/495,911, filed on Jun. 10, 2011, which application is incorporated herein in its entirety by this reference.

### BACKGROUND

The present invention relates to therapeutic shoe soles and methods of manufacturing the same. These therapeutic shoe soles combine unique features, compositions, and structures in order to provide the wearer with enhanced comfort, increased mobility, reduced healing time and disability prevention. The disclosed therapeutic shoe soles are of particular use for medical patients who require enhanced pedorthic qualities.

Shoe soles have been manufactured since prehistory. Traditional shoe soles functioned to merely protect the foot from abrasive surfaces and against injury. These shoe soles included leather or other animal skin wrappings, reed or woven soles, and wooded soles.

Modern shoe soles still primarily protect the foot. Additionally, modern soles are designed for wear resistance, enhanced comfort, support and stability. Recently, there has been increased interest in shoe soles which provide therapeutic benefits through arch support and “rocker” designs to minimize shock during movement, and promotion of proper alignment. Modern soles may include traditional materials and may include contemporary materials such as synthetic plastics and rubbers, natural rubbers such as latex, resins, and other composites.

Advanced shoe sole designs may include air bladders, springs, honeycomb structures and other supports in order to ensure therapeutic benefits. However, despite the current maturity of shoe sole designs, there is always a need for improved sole designs that increase wearer comfort, mobility and support.

In view of the foregoing, a therapeutic shoe sole and methods for manufacturing the same are provided. The present invention provides a novel shoe sole design for reduced healing time, increased comfort, increased mobility and enhanced support for a wearer. The present therapeutic sole includes a novel energy return strip in conjunction with lateral and medial supports, and a rocker design to provide superior orthopedic function.

### SUMMARY

The present invention discloses a therapeutic shoe sole and methods of producing the therapeutic shoe sole. The therapeutic shoe sole increases wearer comfort, decreases healing time post injury, and reduces energy required at the toe-off stance while walking, thereby increasing mobility for weaker, arthritic patients, or injured individuals.

The therapeutic shoe sole has a toe region, a ball region, an arch region and a heel region. Some embodiments of the therapeutic shoe sole include an outsole, a medial and a lateral support, an energy return strip and a midsole.

The outsole includes grips and comes in contact with the ground. The outsole provides the foot protection. The outsole may be coupled to the other elements via adhesive, stitching, or other known technique.

The lateral and medial supports are stiffening elements which provide strength along the length of the sole. When the heel is off the ground, the foot is kept in balance by the solid and stiff medial and lateral support members, preventing over-supination or pronation of the foot. These supports, in conjunction with the energy return strip (also referred to as a dynamic motion stability control plage), may provide the wearer with stability to the entire plantar surface entering into the swing phase.

The energy return strip includes at least one layer of carbon fiber and at least one layer of glass fiber laminated together. The energy return strip curves upwards and may be between 2.5 and 6 cm wide and between 13-32 cm in length. In some embodiments, the energy return strip may include multiple sections with varying thickness and compositions. In some embodiments, the energy return strip includes a first section, a second section and a third section, with the first section is oriented toward the toe region in the therapeutic shoe sole, and the third section is oriented toward the heel in the therapeutic shoe sole.

In some embodiments, the first section is about 0.4-1.2 mm thick, the second section is about 0.8-1.6 mm thick and the third section is about 1.2-2.0 mm thick. In some embodiments, the first section is two layers of glass fiber laminated together, the second section is three layers of glass fiber laminated together, and the third section is four layers of glass fiber and one layer of carbon fiber laminated together.

When the ball of the foot touches the ground, and the toes are bent, the energy return strip provides force to reduce the stress focus on the toes, and assists the foot to easily lift upward. This reduces the energy required to roll from the oblique axis to the hallux on the traverse axis.

Lastly, the midsole includes a shock absorptive material. The midsole curves upward at the heel and toe regions to form a “rocker” design. The midsole may also include cutouts to reduce weight, and include a silicon pad at the heel region for shock absorption.

Note that the various features of the embodiments described above may be practiced alone or in combination. These and other features of embodiments of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an example bottom view illustration of a first outsole embodiment for the therapeutic shoe sole, in accordance with some embodiments;

FIGS. 2A and 2B are example bottom and front view, respectively, illustrations of a second outsole embodiment for the therapeutic shoe sole, in accordance with some embodiments;

FIGS. 3A and 3B are example side view illustrations of the therapeutic shoe sole, in accordance with some embodiments;

FIG. 4A is an example cross sectional side view illustration of the therapeutic shoe sole, in accordance with some embodiments;

FIGS. 4B-D are example cross sectional front view illustrations of the therapeutic shoe sole at various spacing, in accordance with some embodiments;

FIGS. 5A and 5B are example cross sectional side and top view illustrations, respectively, of the midsole with energy return strip of the therapeutic shoe sole, in accordance with some embodiments;

FIGS. 6A and 6B are example side and top view illustrations, respectively, of a first embodiment of the energy return strip of the therapeutic shoe sole, in accordance with some embodiments;

FIGS. 7A and 7B are example side and top view illustrations, respectively, of a second embodiment of the energy return strip of the therapeutic shoe sole, in accordance with some embodiments;

FIG. 8 is an example flow chart diagram for the manufacturing of the therapeutic shoe sole, in accordance with some embodiments; and

FIG. 9 is an example cross sectional top view illustration of a data feedback embodiment of the therapeutic shoe sole, in accordance with some embodiments.

In the drawings, like reference numerals are sometimes used to designate like structural elements. It should also be appreciated that the depictions in the figures are diagrammatic and not necessarily to scale.

### DETAILED DESCRIPTION

Embodiments of the present invention will be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

The present invention relates generally to therapeutic shoe sole designs. In particular, the present therapeutic shoe sole design includes elements of medial and lateral supports, enhanced heel cushioning, and an energy return strip. The unique energy return strip includes one or more layers of glass fiber laminated to one or more layers of carbon fiber. The unique geometry of the energy return strip, in conjunction with its laminate composition reduces pressures to the forefoot area, and reduces effort when walking during the toe-off stance. Further, in conjunction with medial and lateral supports, the energy return strip provides stability to the entire plantar surface when entering the swing phase.

### I. Outsole Embodiments

The therapeutic shoe sole disclosed herein in terms of various embodiments may utilize a number of different outsole designs. Outsoles should be designed to conform to the midsole in conjunction with the medial and lateral supports, as well as the energy return strip. Further, in some embodiments, it may be desirable for the outsole to be a “rocker” type design to reduce shock during walking. Additionally, in many embodiments, it may be desirous that the outsole be designed to provide a solid grip to the intended walking surface. Further design considerations for the outsole include wear resistance, fashion ability, and material costs, availability, weight and workability. In many embodiments, the shoe outsoles may be manufactured from natural rubbers or synthetics, such as polyurethane. Of course, in alternate embodiments, other materials may be selected for the composition of the outsole, including leather, resins, wood, and composites. Further, the outsole may be comprised of any combination of the above referenced materials, as is known in the art.

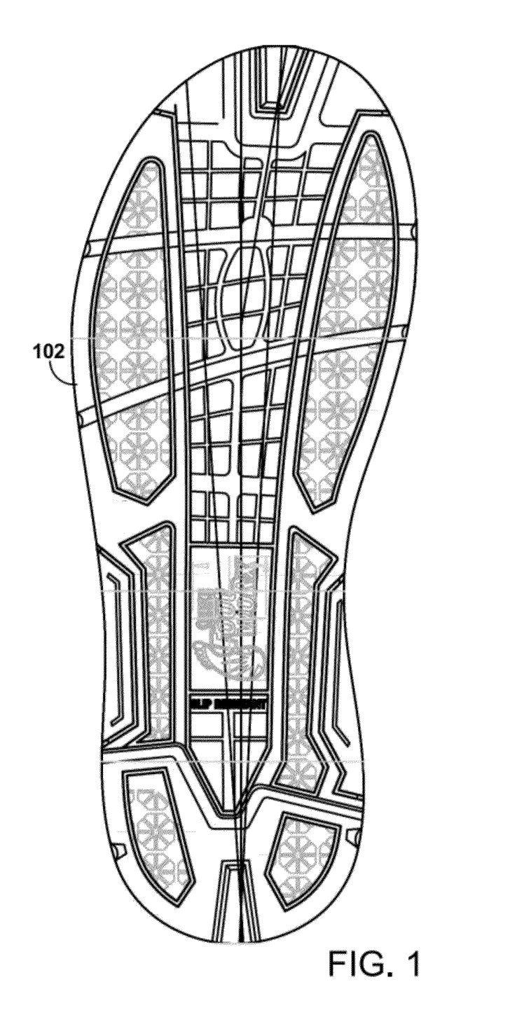

To facilitate discussion, FIG. 1 is an example bottom view illustration of a first outsole embodiment 102 for the therapeutic shoe sole, in accordance with some embodiments. The illustrated outsole includes hexagonal florets to grip smooth surfaces, and parallelogram grips down the center of the outsole for general traction, wear resistance and stiffness.

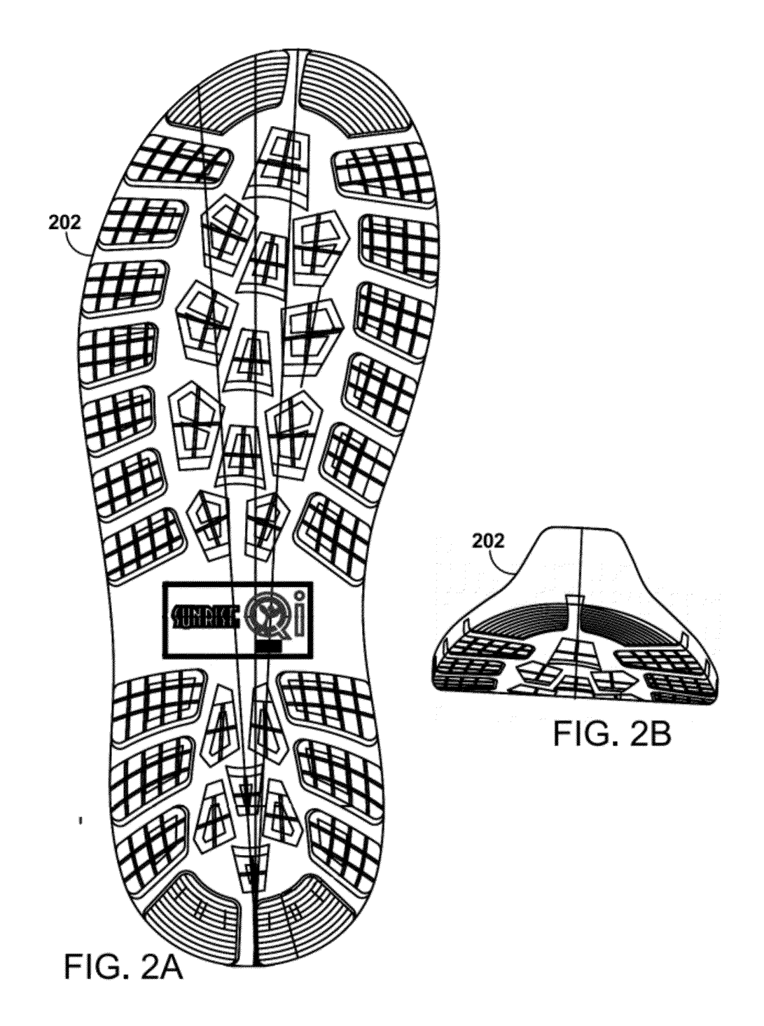

A second outsole embodiment 202 may be seen at FIG. 2A. This second outsole embodiment 202 has wider spaced grips, and is suitable for rougher terrain, and may be better suited for wet conditions. The heel and toe of the outsole includes ribbing for improved traction when the heel is placed, and toe-off stance, respectively.

FIG. 2B is a frontal view of the second outsole embodiment 202, in accordance with some embodiments. The outsole may, in some embodiments, turn up at the toe and heel regions, as illustrated. This curvature is known as a “rocker” design. Rocker designs promote a rolling heel-to-toe gait which may reduce shock and increases foot comfort. However, rocker style shoes may also be more difficult to balance in, and as such, embodiments of the present invention are also directed toward shoe designs which are relatively less curved than traditional rocker style designs.

Also of note, any suitable tread design may be utilized in conjunction of some embodiment of the therapeutic shoe sole. Treads may be designed for particular surfaces, applications, or aesthetics. These variations are considered to be entirely within the scope of the disclosure, although separate mention or illustration of every possible variation would not be practical. It is obvious, however, that persons skilled in the art will be able to design an unlimited range of variations to suit specific applications.

### II. Energy Return Strip Reinforced Midsole Embodiments

As noted above, the therapeutic shoe sole includes the outsole coupled to medial and lateral supports, and a midsole including an energy return strip. This combination of features, and in particular the unique energy return strip, enables the therapeutic shoe sole to reduce healing time in medical patients, increase shoe comfort, increase mobility and reduce energy requirements during the toe-off stance during gait.

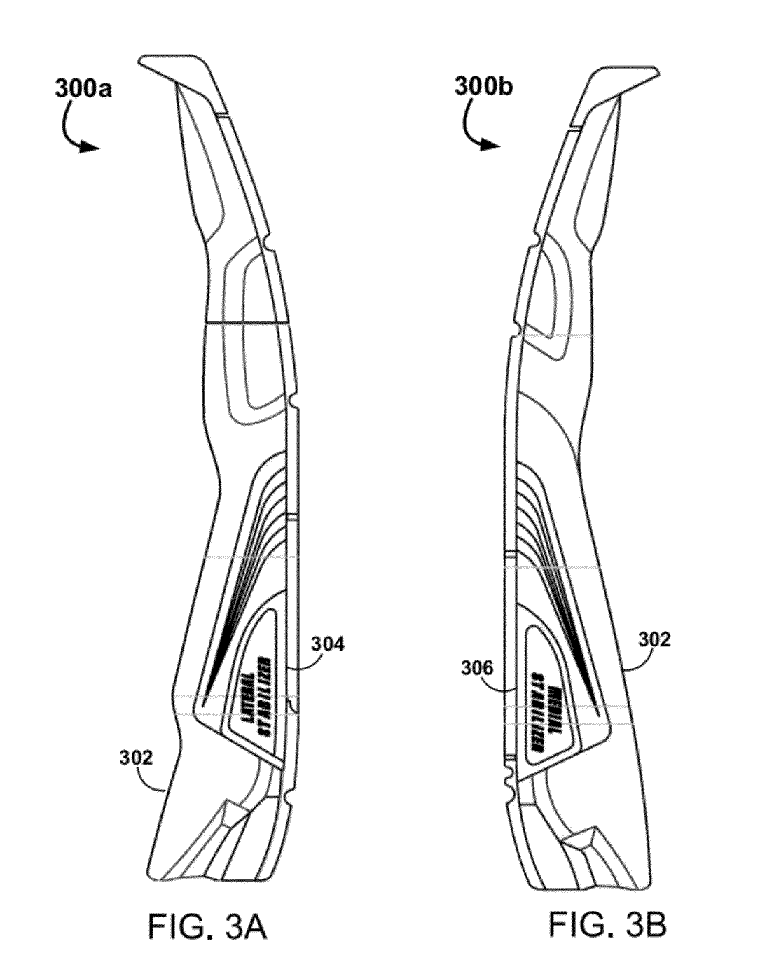

FIGS. 3A and 3B are example side view illustrations of the therapeutic shoe sole, in accordance with some embodiments. The outside view is shown at 300a in relation to FIG. 3A. Here the sole 302 is illustrated with a lateral support 304 affixed between the heel and pad/ball regions of the shoe. Conversely, the inside view is illustrated at 300b in relation to FIG. 3B, where the medial support 306 may be seen.

Medial and lateral supports may include stiffening elements which provide strength along the length of the sole. These supports, in conjunction with the energy return strip, may provide the wearer with stability to the entire plantar surface entering into the swing phase.

When the heel is off the ground, the foot is kept in balance by the solid and stiff support members, preventing over-supination or pronation of the foot. When the ball of the foot touches the ground, and the toes are bent, the energy return strip provides force to reduce the stress focus on the toes, and assists the foot to easily lift upward. This reduces the energy required to roll from the oblique axis to the hallux on the traverse axis.

The medial and lateral supports may be comprised of any suitably stiff or ridged materials. In some embodiments the medial and lateral supports are comprised of a plastic, resin or other synthetic polymer material. In alternate embodiments, the medial and lateral supports may be comprised of metal. In yet other embodiments, the medial and lateral supports may be comprised of carbon and/or glass fiber.

In addition to more clearly illustrating the geometry and location of the medial and lateral supports, FIGS. 3A and 3B further illustrate a therapeutic “rocker” sole design. Typical athletic shoes that include a rocker design maintain a consistent curvature along the bottom of the shoe. In contrast, some embodiments, such as the one illustrated here, incorporate a flat shoe bottom from the pad/ball region to the beginning of the heel region. The heel then turns up, as does the toe region extending into the pad/ball region. The benefit of this design includes increased balance over continually curved designs, and yet increased comfort and foot alignment during walking

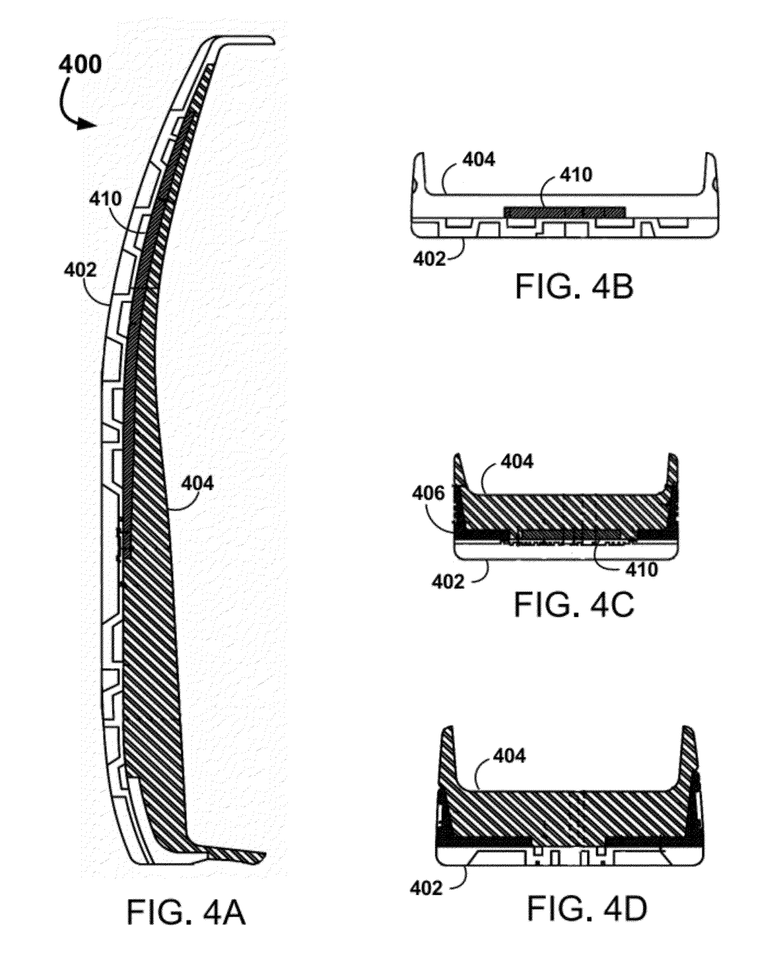

Continuing, FIG. 4A is an example cross sectional side view illustration 400 of the therapeutic shoe sole, in accordance with some embodiments. Here the outsole 402 with treading is seen in close contact with the energy return strip 410 and midsole 404. The midsole 404 may include foam cushioning, elastomer, rubber, or any other suitable material. Generally, midsole material may be selected for moisture properties, shock absorption, weight, wear resistance and ability to mold to the foot. In some embodiments, the midsole 404 may include a single material. In alternate embodiments, the midsole 404 may include a combination of materials, as is desired. In some embodiments, the heel portion of the midsole may include a silicon material for its shock absorptive properties. Also, note that, in some embodiments, the midsole increases in thickness across the arch and into the heel portion. This increasing thickness is in response to the weight distribution on the foot when walking, and in support of the arch of the foot.

FIGS. 4B-D are example cross sectional front view illustrations of the therapeutic shoe sole at various spacing, in accordance with some embodiments. FIG. 4B is a cross section of the sole at the pad/ball or toe region. The midsole 404 portion is thin in these regions, and the energy return strip 410 is present. The outsole 402 can also be seen protecting the bottom of the sole.

FIG. 4C is a cross section of the sole at the arch region. Again, the outsole 402 is present, as is the midsole 404 and energy return strip 410. Additionally, at this region are the medial and lateral supports 406. The medial and lateral supports, in this embodiment, are L shaped structures which extend up the side of the midsole and down along the bottom of the midsole between the outsole. By overlapping the energy return strip 410 and medial and lateral supports 406 in this region the desired support can be achieved.

FIG. 4D is a cross section of the sole at the heel region. Again, the outsole 402 is present, as is the midsole 404 and medial and lateral supports 406. The energy return strip does not extend down to the heel region in this embodiment. Note that, in this embodiment, the base of the medial and lateral supports 406 extends further toward the center of the sole at this region.

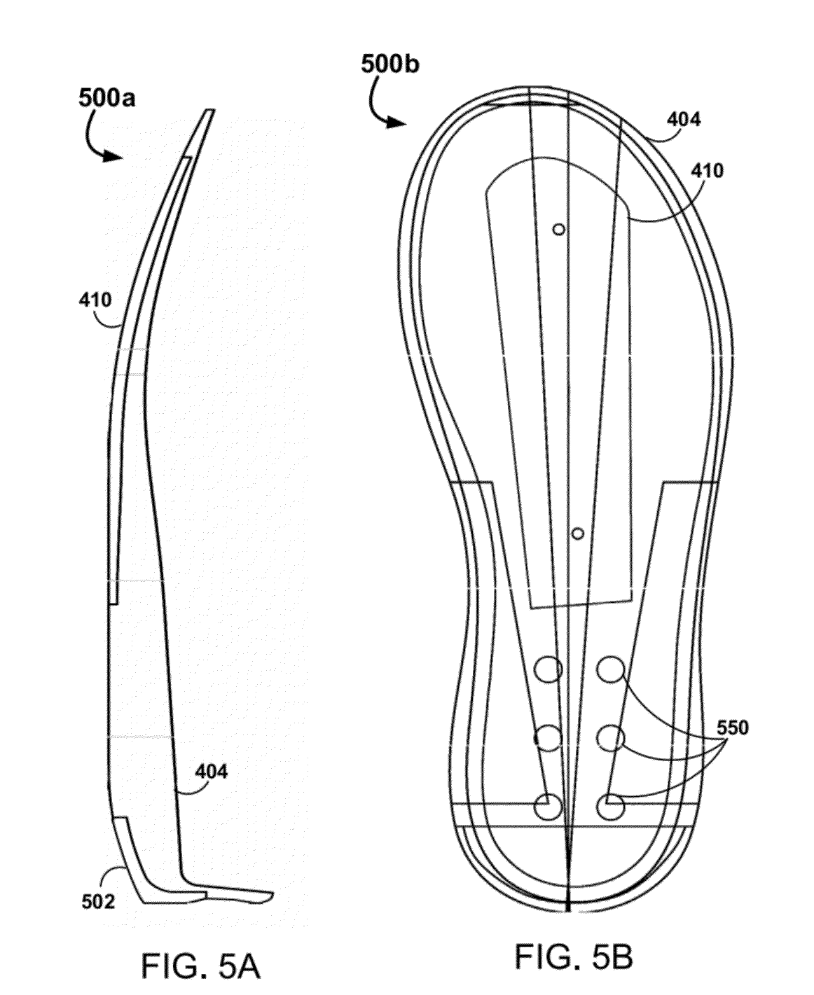

FIGS. 5A and 5B are example cross sectional side and top view illustrations, respectively, of the midsole 404 with energy return strip 410 of the therapeutic shoe sole, in accordance with some embodiments. In this illustration at the base of the heel region is a silicon pad 502 to further enhance foot comfort and shock absorption. The top view 500b of the midsole 404 and energy return strip 410 illustrates the geometry and location of the energy return strip 410. Additionally, one or more cutouts 550 may be made in the midsole 404 to reduce overall sole weight.

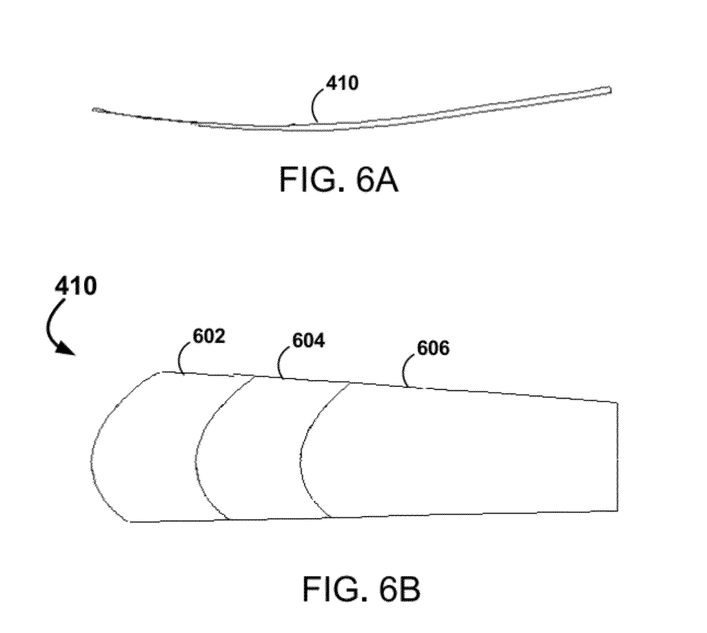

FIGS. 6A and 6B are example side and top view illustrations, respectively, of a first embodiment of the energy return strip 410 of the therapeutic shoe sole, in accordance with some embodiments. The energy return strip 410 may, in some embodiments, may include one or more layers of carbon fiber in combination with one or more layers of glass fiber laminated together. In some embodiments, the energy return strip 410 may include three sections 602, 604 and 606, respectively, with varying layers and thicknesses. In some particular embodiments, the first section 602 may be between 0.4-1.2 mm in thickness. The second section 604 may be between 0.8-1.6 mm in thickness. The third section 606 is between 1.2-2.0 mm in thickness. The overall width of the energy return strip 410 may be about 2.5-6 cm in width. Overall length of the energy return strip 410 may be about 13-20 cm in length.

In some particular embodiments, the first portion 602 of the energy return strip 410 may be comprised of two (2) layers of glass fiber. The second portion 604 may be comprised of three (3) layers of glass fiber. The third portion 606 may be comprised of four (4) layers of glass fiber and one (1) carbon fiber layer. The layers may be laminated together to provide an energy return strip 410 with the desired thickness, stiffness and elasticity. Dependent upon the wearer's foot size and weight, alternate embodiments of the energy return strip 410 may include more or fewer layers of glass and/or carbon fiber material in order to achieve desirable properties.

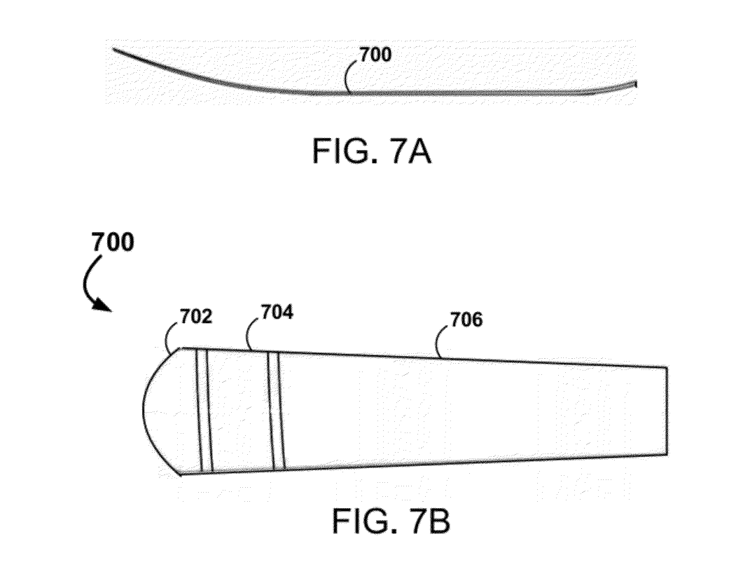

FIGS. 7A and 7B are example side and top view illustrations, respectively, of a second embodiment 700 of the energy return strip of the therapeutic shoe sole, in accordance with some embodiments. The second example embodiment 700 likewise may comprise three sections 702, 704 and 706, respectively. These sections may likewise be about 0.4-1.2 mm in thickness, 0.8-1.6 mm in thickness, and 1.2-2.0 mm in thickness for the three sections, respectively. Layering compositions may also mirror the energy return strip 410. However, unlike the energy return strip 410, the second embodiment may be substantially symmetrically shaped along the longitudinal axis. Further, the end of the third section 706 may curve up at the end, as is evident at FIG. 7A. Lastly, this embodiment may be substantially longer than the energy return strip 410. For example, the second embodiment 700 may be about 20-32 cm in total length. This enables the second embodiment energy return strip 700 to extend further down the length of the sole, enhancing support and increasing ease of mobility on the toe-off stance.

As previously noted, the energy return strip 410 or 700 reduces the effort required in the toe-off stance while walking. By way of further explanation, when the ball of the foot touches the ground, and the toes are bent, the energy return strip provides force to reduce the stress focus on the toes, and assists the foot to easily lift upward. This reduces the energy required to roll from the oblique axis to the hallux on the traverse axis.

### III. Methods of Manufacturing

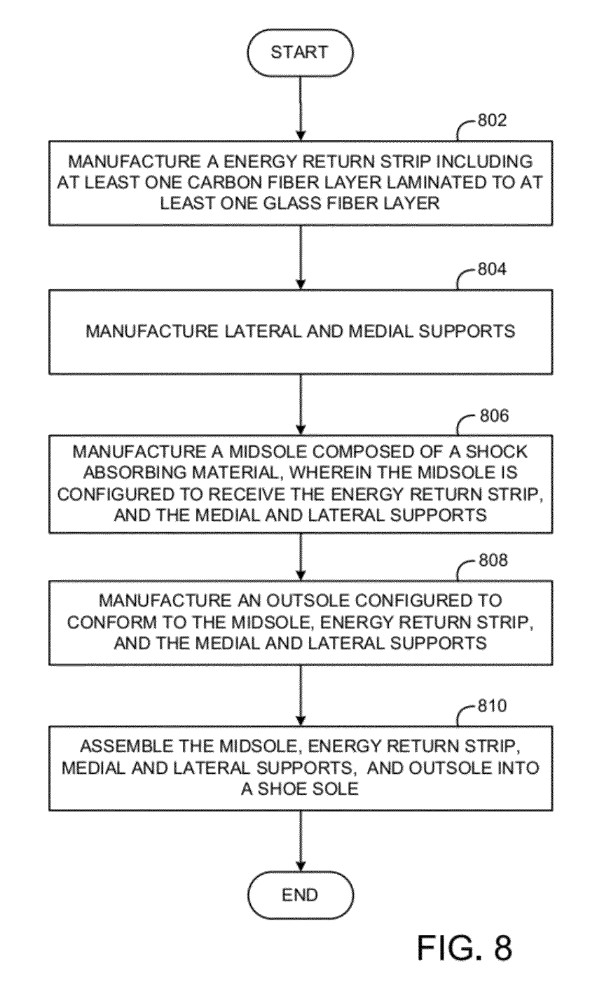

FIG. 8 is an example flow chart diagram for the manufacturing of the therapeutic shoe sole, in accordance with some embodiments. The process begins (at 802) with the manufacturing of an energy return strip including at least one layer of carbon fiber laminated to at least one layer of glass fiber. In some embodiments, the energy return strip may be curved, and have varying thickness at different sections. The section may additionally include different layer compositions.

For example, some embodiments of the energy return strip may include three sections; the first section about 0.4-1.2 mm in thickness and comprised of two layers of glass fiber, the second section about 0.8-1.6 mm in thickness and comprising three layers of glass fiber, and the last section about 1.2-2.0 mm in thickness and comprising four layers of glass fiber and one layer of carbon fiber. Note that more, or fewer, layers are considered within the scope of this disclosure. Further, alternate or additional layers of differing materials are considered within the scope of this disclosure, such as resin layers, additional carbon fiber layers, metals and plastics.

After manufacture of the energy return strip lateral and medial supports may be manufactured (at 804). In some embodiments, the lateral and medial supports may be comprised of plastic, resin, metal, carbon fiber, or other material of suitable rigidity. The lateral and medial supports may, in some embodiments, be L shaped and configured to conform to the outside and inside of the sole.

Next, a midsole is manufactured (at 806) which is configured to conform to the energy return strip and the lateral and medial supports. The midsole may be manufactured from a suitable material for shock absorption, foot comfort, weight, and moisture properties. In some embodiments, the midsole gradually thickens from the toe region of the sole to the heel region of the sole. Additionally, at the heel region of the midsole there may be a silicon pad, or other shock absorption material. Cutouts may be made in the midsole to reduce weight at the arch and heel regions.

Further, an outsole is also manufactured (at 808) which is configured to adhere to the midsole, energy return strip, and lateral and medial supports. The outsole may be any suitable material, but in some embodiments may include natural rubber or synthetics, such as polyurethane. Outsole material may be selected for coefficient of friction, wear, softness, and workability. The outsole may have treads designs molded into the material for aesthetic purposes, and to ensure better grip on surfaces.

The sole may then be assembled (at 810) by coupling the outsole, lateral and medial supports, energy return strip and midsole together utilizing stitching, adhesives, or other known techniques. This concludes the manufacturing of the complete therapeutic sole.

### IV. Data Collecting Therapeutic Shoe Sole

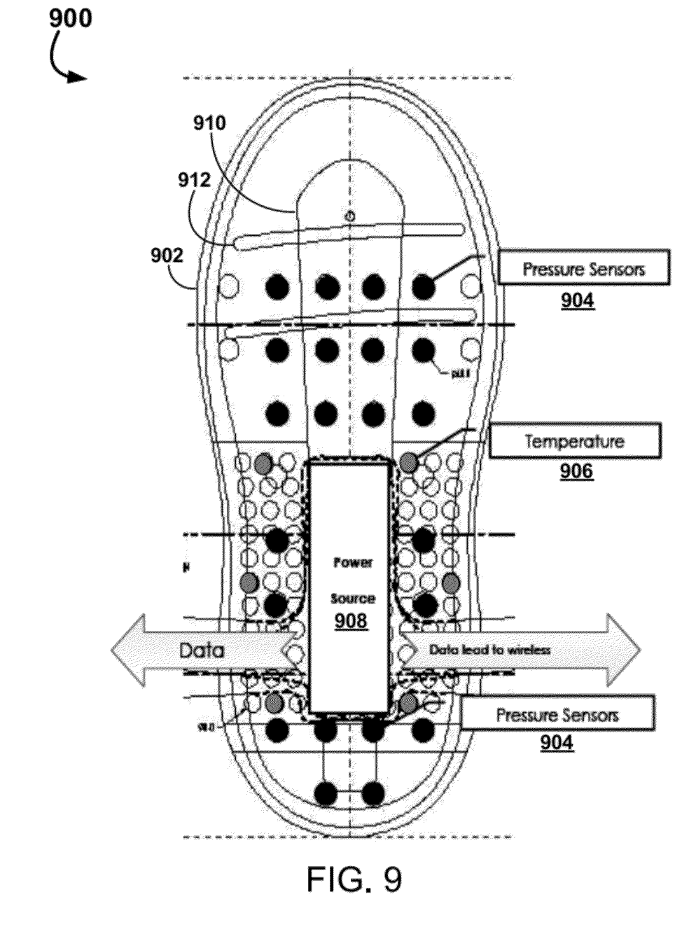

Lastly, in some embodiments, it may be desirous to generate a shoe sole capable of collecting and transmitting data regarding the wearer for therapeutic purposes. FIG. 9 is an example cross sectional top view illustration of a data feedback embodiment of the therapeutic shoe sole, in accordance with some embodiments, and shown generally at 900. The basic structure of this shoe sole is similar to previous embodiments in that a midsole 902 couples to an energy return strip 910. One or more perpendicular supports 912 may also be included within the midsole to further increase foot support. Alternatively, in some other embodiments, the data collection and utilization aspects detailed below in relation to this sole design may be independent of the energy return strip 910 and other support features detailed above.

Key differentiating elements of this sole is the presence of a power source 908 and a plurality of pressure sensors 904 across the ball/pad, arch and heel regions of the sole. Additionally, one or more temperature sensors 906 may record the foot's temperature. Pressure and temperature data may be recorded and periodically downloaded by a physician or wearer, or may be continually transmitted via a wireless interface. The collected pressure and temperature data may inform the wearer or physician as to the wearer's gait and physiological condition. This data may be utilized to tailor therapy, or modify behavior.

Additionally, in some embodiments, the sole may include an imbedded computer which may be programmable to adjust the sole temperature and/or plantar pressure to prevent foot ulceration. Such a sole may be of particular use for military shoe applications, shoes targeting diabetic wearers, and safety shoes.

The programmable imbedded computer may monitor foot pressures and temperatures using the pressure sensors 904 and temperature sensors 906, respectively. When uneven or excessive pressure is sensed the computer may drive pumps capable of inflating bladders within the sole to adjust plantar pressures. Alternatively, actuators and mechanical means may be utilized to adjust plantar pressure. When temperatures at the sole are uneven or excessive the programmable imbedded computer may adjust sole temperature to prevent thermal necrosis due to pressure and friction. Temperature modulation may include utilizing air circulation, fluid circulation via embedded fluid channels, and/or peltier (solid state) cooler.

In some embodiments, the insole may include a tri-laminar structure with a top layer that is comprised of 3D porous individual cells made of polyethylene and synthetic polymer. This 3D polymer structure may be configured to facilitate air movement. In some embodiments, the cell structure may resemble a matrix of polymer beads; however, alternate structures and 3D designs are considered within the scope of this disclosure. In these embodiments, the cell density/hardness may be modulated by the imbedded computer. Likewise, in these embodiments, the imbedded computer may also control air flow-ability within the 3D polymer layer.

Further, in some embodiments, the programmable computer may further include a global positioning system (GPS) for position tracking. Such a system may be of particular use for emergency workers, military personnel, and Alzheimer's or dementia patients.

In sum, therapeutic shoe soles and methods for their manufacture is provided. While a number of specific examples have been provided to aid in the explanation of the present invention, it is intended that the given examples expand, rather than limit the scope of the invention. For example, while some embodiments of the invention are illustrated with a three sectioned energy return strip, it is entirely within the scope of the invention for alternate energy return strip geometries, such as more sections or a single strip thickness.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A therapeutic shoe sole useful in conjunction with a wearer, the therapeutic shoe sole having a toe region, a ball region, an arch region and a heel region, the therapeutic shoe sole comprising:
an outsole;
a medial and a lateral support coupled to the outsole between the heel region and the ball region;
an energy return strip comprising at least one layer of carbon fiber and at least one layer of glass fiber laminated together, wherein the energy return strip curves upwards; and
a midsole comprised of shock absorptive material, wherein the midsole couples to the energy return strip, the medial and lateral supports and the outsole.

2. The therapeutic shoe sole of claim 1, wherein the midsole curves upward at the heel and toe regions.

3. The therapeutic shoe sole of claim 1, wherein the midsole includes cutouts to reduce weight.

4. The therapeutic shoe sole of claim 1, wherein the midsole includes a silicon pad at the heel region.

5. The therapeutic shoe sole of claim 1, wherein the energy return strip includes section of varying thickness.

6. The therapeutic shoe sole of claim 5, wherein the energy return strip includes a first section, a second section and a third section, and wherein the first section is oriented toward the toe region in the therapeutic shoe sole, and the third section is oriented toward the heel in the therapeutic shoe sole.

7. The therapeutic shoe sole of claim 6, wherein the first section is about 0.4-1.2 mm thick, the second section is about 0.8-1.6 mm thick and the third section is about 1.2-2.0 mm thick.

8. The therapeutic shoe sole of claim 6, wherein the first section is comprised of two layers of glass fiber, the second section is comprised of three layers of glass fiber, and the third section is comprised of four layers of glass fiber and one layer of carbon fiber.

9. The therapeutic shoe sole of claim 1, wherein the energy return strip is between about 13-20 cm in length.

10. The therapeutic shoe sole of claim 1, wherein the energy return strip is between about 20-32 cm in length.

11. The therapeutic shoe sole of claim 1, wherein the energy return strip is between about 2.5-6 cm in width.

12. A method for manufacturing an energy return strip, useful in association with a therapeutic shoe sole, the method comprising:
shaping layers of glass fiber and carbon fiber such that the laminated layers form a strip that curves upward and is between about 2.5-6 cm in width and between about 13-32 cm in length;
laminating together two layers of glass fiber at a first section;
laminating together three layers of glass fiber at a second section; and
laminating together four layers of glass fiber and one layer of carbon fiber at a third section.

13. The method of claim 12, wherein the first section is about 0.4-1.2 mm thick, the second section is about 0.8-1.6 mm thick and the third section is about 1.2-2.0 mm thick.

14. The method of claim 12, wherein the shaping includes cutting the glass fiber and the carbon fiber.

15. The method of claim 12, wherein the shaping includes molding the glass fiber and the carbon fiber.

16. An energy return strip, useful in association with a therapeutic shoe sole, the energy return strip comprising:
a first section comprising two layers of glass fiber laminated together;
a second section comprising three layers of glass fiber laminated together; and
a third section comprising four layers of glass fiber and one layer of carbon fiber laminated together, wherein the first section is the front region of the energy return strip, the second section is the middle region of the energy return strip, and the third section is the aft region of the energy return strip.

17. The energy return strip of claim 16, wherein the first section is about 0.4-1.2 mm thick, the second section is about 0.8-1.6 mm thick and the third section is about 1.2-2.0 mm thick.

18. The energy return strip of claim 16, wherein the energy return strip curves upward.

19. The energy return strip of claim 16, wherein the energy return strip is between about 2.5-6 cm in width and between about 13-20 cm in length.

20. The energy return strip of claim 16, wherein the energy return strip is between about 2.5-6 cm in width and between about 20-32 cm in length.
